(19) United States
(12) Patent Application Publication
(10) Pub. No.: US 2024/0268451 A1
(43) Pub. Date: Aug. 15, 2024

(54) AEROSOL-GENERATING DEVICE AND MEDIUM RECEIVING ROD

(71) Applicant: KT&G CORPORATION, Daejeon (KR)

(72) Inventors: Insu PARK, Daejeon (KR); Chan Min KWON, Daejeon (KR); Mi Jeong LEE, Daejeon (KR); Min Kyu KIM, Daejeon (KR)

(73) Assignee: KT&G CORPORATION, Daejeon (KR)

(21) Appl. No.: 18/567,844

(22) PCT Filed: Oct. 7, 2022
(86) PCT No.: PCT/KR2022/015153

§ 371 Date: Dec. 7, 2023

(30) Foreign Application Priority Data
Oct. 7, 2021 (KR) 10-2021-0132906

(51) Int. Cl. A24D 1/20; A24B 15/167; A24D 1/00; A24D 1/04; A24D 3/06; A24D 3/17; A24F 40/10; A24F 40/20; A24F 40/30

(52) U.S. Cl. CPC A24D 1/20; A24B 15/167; A24D 1/002; A24D 1/045; A24D 3/061; A24D 3/17; A24F 40/10; A24F 40/20; A24F 40/30

(57) ABSTRACT

An aerosol-generating device includes a receiver for receiving a medium receiving rod in a replaceable manner, an atomizer that generates aerosol, and a power supply for providing power required to heat the atomizer, and a medium included in the medium receiving rod is transferred by the aerosol passing through the medium receiving rod.

### TECHNICAL FIELD

One or more embodiments of the present disclosure relate to an aerosol-generating device and a medium receiving rod.

### BACKGROUND ART

Recently, the demand for alternative items that overcome the disadvantages of traditional cigarettes has increased. For example, there is increasing demand for devices (e.g., cigarette-type electronic cigarettes) that generate aerosol by electrically heating cigarette sticks. Accordingly, research on electrically heated aerosol-generating devices and aerosol-generating articles (e.g., cigarette sticks) applied thereto is being actively conducted. For example, Korean Patent Publication No. 10-2017-0132823 discloses a non-combustible type of a flavor aspirator, a flavor and aroma taste unit, and an atomization unit.

### DISCLOSURE OF THE INVENTION

### Technical Goals

An aspect provides an aerosol-generating device and a medium receiving rod to transition nicotine through indirect heating of a medium through aerosol.

An aspect provides an aerosol-generating device and a medium receiving rod that improve hygiene by configuring an indirect heated type (non-heated type) electronic cigarette using a disposable stick and provide a uniform flavor during nicotine transition.

### Technical Solutions

According to an aspect, there is provided an aerosol-generating device. The aerosol-generating device, according to an example embodiment, may include a receiver for receiving a medium receiving rod in a replaceable manner, an atomizer that generates aerosol, and a power supply for providing power required to heat the atomizer, wherein a medium included in the medium receiving rod may be transferred by the aerosol passing through the medium receiving rod.

The medium receiving rod may include an alkaline pH adjuster.

According to another aspect, there is provided a medium receiving rod. The medium receiving rod may include a first filter segment disposed at the upstream end of the medium receiving rod, a second filter segment disposed downstream of the first filter segment, a cavity segment disposed between the first filter segment and the second filter segment, and a filter rod disposed at the downstream end of the medium receiving rod, and the filter rod may include a cooling segment and a mouthpiece segment, and the cavity segment may include the medium provided in a form of medium pulp.

The medium may be provided in the form of tobacco pulp.

The tobacco pulp may be manufactured by a compression process.

The medium receiving rod may include a disposable cigarette.

The atomizer may include a liquid storage tank for storing a liquid composition that generates aerosol, a liquid transfer means for facilitating a transfer of the liquid composition, and a heater for heating the liquid composition.

The liquid composition of the atomizer may further include a flavoring agent.

The heating temperature of the heater is 270 degrees (° C.) or less.

According to another aspect of embodiments, a medium receiving rod used with the aerosol-generating device is provided. The medium receiving rod may include a first filter segment disposed at the upstream end of the medium receiving rod, a second filter segment disposed downstream of the first filter segment, and a cavity segment disposed between the first filter segment and the second filter segment, and comprising medium pulp and a pH adjuster.

The pH adjuster may include an alkaline salt.

The medium receiving rod may further include a filter rod disposed at the downstream end of the medium receiving rod, and comprising a cooling segment and a mouthpiece segment.

The mouthpiece segment may include a flavoring agent capsule.

The first filter segment and the second filter segment may include a paper material.

### Advantageous Effects

An aerosol-generating device and a medium receiving rod according to an example embodiment may transfer nicotine through indirect heating of the medium by aerosol. The aerosol-generating device and the medium receiving rod according to an example embodiment may improve hygiene by configuring an indirect heated type (a non-heated type) electronic cigarette using a disposable stick and provide a uniform flavor during nicotine transition.

The effects of the aerosol-generating device and the medium receiving rod according to an example embodiment are not limited to those described above, and other effects not mentioned may be clearly understood by those skilled in the art from the following description.

### BRIEF DESCRIPTION OF DRAWINGS

FIG. 1a is a diagram schematically illustrating an aerosol-generating device according to an example embodiment;

FIG. 1b is a diagram schematically illustrating an aerosol-generating device according to another example embodiment;

FIG. 2a is a diagram schematically illustrating an aerosol-generating system in which a medium receiving rod is received in an aerosol-generating device according to an example embodiment;

FIG. 2b is a diagram schematically illustrating an aerosol-generating system in which a medium receiving rod is received in an aerosol-generating device according to another example embodiment;

FIG. 3a is a diagram schematically illustrating a structure of a medium receiving rod according to an example embodiment;

FIG. 3b is a diagram schematically illustrating a structure of a medium receiving rod according to another example embodiment; and

FIG. 4 is a diagram for explaining a principle and condition in which a vortex is generated in a medium receiving rod according to an example embodiment.

### BEST MODE FOR CARRYING OUT THE INVENTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a” “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof. Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the examples with reference to the accompanying drawings, like reference numerals refer to like constituent elements and a repeated description related thereto will be omitted. In the description of the example embodiments, a detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The constituent element, which has the same common function as the constituent element included in any one example embodiment, will be described by using the same name in other example embodiments. Unless disclosed to the contrary, the configuration disclosed in any one example embodiment may be applied to other example embodiments, and the specific description of the repeated configuration will be omitted.

In the following example embodiments, a “moisturizer” may mean a material that may facilitate the formation of visible smoke and/or aerosol. Examples of the moisturizer may include glycerin (GLY), propylene glycol (PG), ethylene glycol, dipropylene glycol, diethylene glycol, triethylene glycol, tetraethylene glycol, and oleyl alcohol, but are not limited thereto. In the art, the moisturizer may be used interchangeably in terms such as an aerosol-forming agent, a wetting agent, and the like.

In the following example embodiments, the “aerosol-forming substrate” may mean a material that may form aerosol. The aerosol may include a volatile compound. The aerosol-forming substrate may be solid or liquid.

For example, a solid aerosol-forming substrate may include a solid material based on raw tobacco materials such as reconstituted tobacco leaves, cut tobacco, and restructured tobacco, and the like, and a liquid aerosol-forming substrate may include a liquid composition based on nicotine, tobacco extract, and/or various flavoring agents. However, the scope of the present disclosure is not limited to these examples.

In the following example embodiments, the “aerosol-generating device” may mean a device that generates aerosol using the aerosol-forming substrate to generate aerosol that may be directly inhaled into lungs of a user through a mouth of a user.

In the following example embodiments, the “medium receiving rod” may mean an item that receives a medium. A representative example of the medium receiving rod may be a cigarette, but the scope of the present disclosure is not limited thereto.

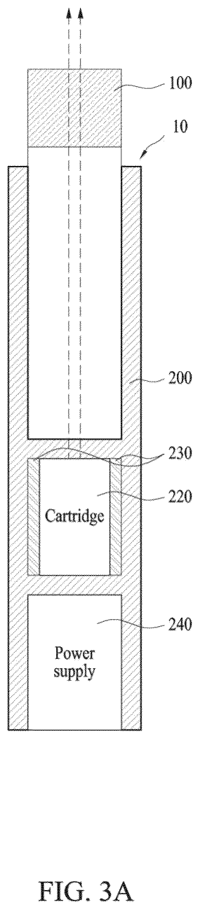

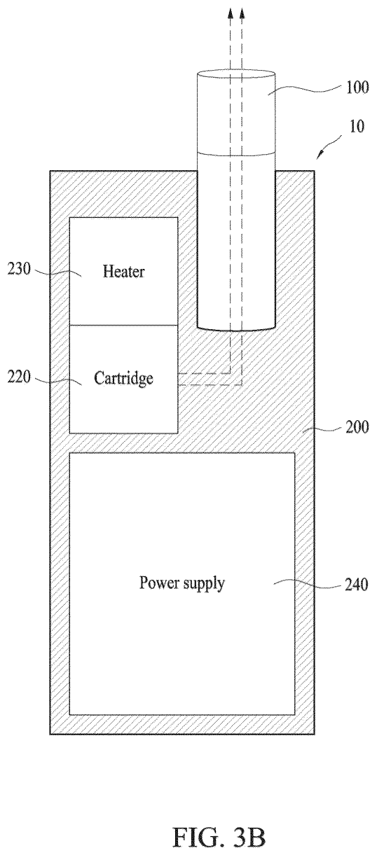

In the following example embodiments, the “upstream” or “upstream direction” may mean a direction away from the oral region of a user (a smoker), and the “downstream” or “downstream direction” may mean a direction close to the oral region of a user. The terms upstream and downstream may be used to describe the relative positions of the elements including the medium receiving rod. For example, in a medium receiving rod 100 illustrated in FIG. 3a, a cavity rod 120 is positioned at the upstream or upstream direction of a filter rod 140, and the filter rod 140 is positioned at the downstream or downstream direction of the cavity rod 120.

In the following example embodiments, the “puff” means inhalation of a user, and inhalation means a situation in which a smoke is pulled into a mouth of a user, nasal cavity, or lungs through a mouth or nose of a user.

Hereinafter, various example embodiments according to the accompanying drawings will be described.

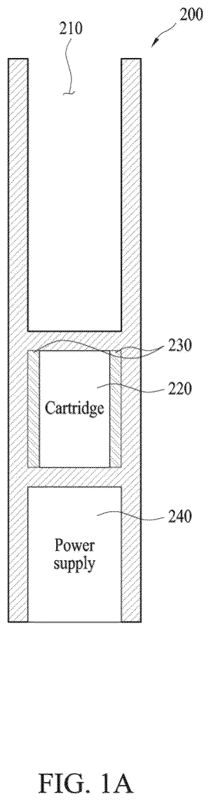

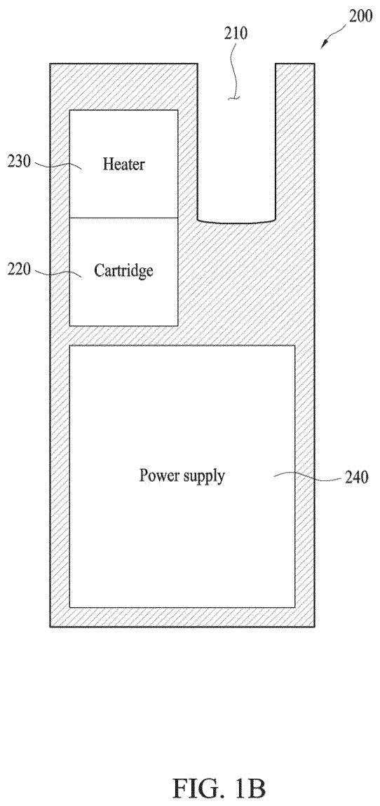

FIGS. 1a and 1b are diagrams schematically illustrating an aerosol-generating device according to some example embodiments. FIG. 1a illustrates that a cartridge 220 and a heater 230 are arranged in parallel, and FIG. 1b illustrates that the cartridge 220 and the heater 230 are arranged in a line.

Referring to FIGS. 1a and 1b, an aerosol-generating device 200 according to the example embodiment may include a housing, a receiver 210, a cartridge 220, a heater 230, and a power supply 240. In this case, an atomizer may include the cartridge 220 and the heater 230, and the atomizer may generate aerosol. Although only relevant components are illustrated in the example of FIGS. 1a and 1b, it may be apparent to those skilled in the art that other general-purpose components may be further included in addition to the components illustrated in FIGS. 1a and 1b. For example, the aerosol-generating device 200 may further include an input module for receiving a command from a user, and an output module for outputting information such as a state of the device, smoking information, and the like. Hereinafter, each component of the aerosol-generating device 200 will be described.

The housing may form an exterior of the aerosol-generating device 200. In addition, the housing may form the receiver 210 for receiving the medium receiving rod 100 (e.g., a cigarette). It may be desirable that the housing is implemented with a material that may protect internal components.

Next, the receiver 210 may be a space that may receive the medium receiving rod 100. The receiver 210 may include a coupling structure for holding the medium receiving rod without falling out when the medium receiving rod 100 is received in the receiver 210. The coupling structure may include, for example, a coupling structure using interference fit, a coupling structure using a magnetic material, a coupling structure using an electromagnetic material, and the like. In addition, the medium receiving rod 100 received in the receiver 210 may be in the form of a stick or cigarette that is replaceable as will be described later.

Next, the atomizer may further include a liquid storage tank, a liquid transfer means, and a heater. However, the present disclosure is not limited thereto, and the atomizer may further include other components. In addition, the cartridge 220 may be manufactured to be detached/attached from the heater 230 or may be manufactured integrally with the heater 230. The liquid storage tank may store a liquid composition. The liquid composition may be a liquid including tobacco-containing materials or nicotine-containing materials, or non-tobacco materials. For example, the liquid composition may include water, solvent, ethanol, plant extract (e.g., tobacco extract), fragrance, an aerosol-forming agent, a flavoring agent, and/or a vitamin mixture. The fragrance may include menthol, peppermint, spearmint oil, various fruit flavoring components and the like, but is not limited thereto. The flavoring agent may include components that may provide various flavors to a user. The vitamin mixture may be a mixture of at least one of vitamin A, vitamin B, vitamin C, and vitamin E, but is not limited thereto. The liquid composition may further include a moisturizer. The moisturizer may be glycerin (VG), polypropylene glycol (PG), sorbitol, or a mixture thereof, but is not limited thereto. The liquid transfer means may transfer the liquid composition stored in the liquid storage tank to the heater 230. For example, the liquid transfer means may be a wick element such as cotton fiber, ceramic fiber, glass fiber, and porous ceramic, but is not limited thereto.

Next, the heater 230 may form aerosol by heating the liquid composition stored in the cartridge 220. For example, the heater 230 may form aerosol by heating the liquid composition transferred by the liquid transfer means. The formed aerosol may pass through the medium receiving rod 100 and be delivered to a user. That is, the aerosol formed by heating of the heater 230 may move along the airflow path of the medium receiving rod 100, and the airflow path may be configured such that aerosol formed by the liquid composition material stored in the cartridge may pass through the medium receiving rod 100 and be transferred to a user. For example, the heater 230 may be made of a coil, ceramic, a metal mesh, a conductive filament, or the like, but is not limited thereto. Also, the heating temperature of the heater 230 may be 270° C. or less, desirably 240° C. or less, and more desirably 200° C. or less. As will be described later, when medium pulp P includes a pH adjuster, the minimum temperature at which nicotine may be transferred is lowered. As a result, the heating temperature of the heater 230 may be lowered, and accordingly, electrical efficiency of an aerosol-generating system may be improved.

The cartridge 220 and the heater 230 may be collectively referred to as a catomizer, an atomizer, a vaporizer, or the like.

Next, the power supply 240 may supply power used to operate the aerosol-generating device 200. For example, the power supply 240 may supply power so that the heater 230 may heat the medium receiving rod 100. In addition, the power supply 240 may supply power required for operating electrical components such as a display (not shown), a sensor (not shown), and a motor (not shown) installed in the aerosol-generating device 200.

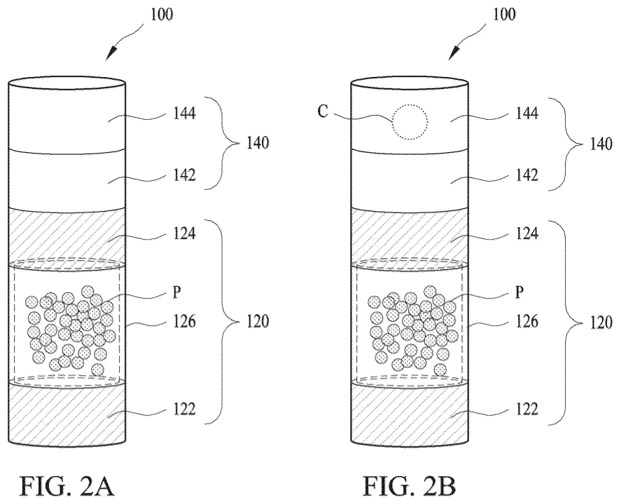

Hereinafter, the medium receiving rod 100 according to some example embodiments will be described with reference to FIGS. 2a and 2b.

FIGS. 2a and 2b are diagrams schematically illustrating a structure of the medium receiving rod 100 according to some example embodiments.

As illustrated in FIGS. 2a and 2b, the medium receiving rod 100 may include the cavity rod 120 and the filter rod 140. The medium receiving rod 100 may further include a wrapper that wraps the rod. Although only relevant components are illustrated in the example of FIGS. 2a and 2b, it may be apparent to those skilled in the art that other general-purpose components may be further included in addition to the components illustrated in FIGS. 2a and 2b. Hereinafter, each component of the medium receiving rod 100 will be described.

The cavity rod 120 is a rod including a cavity or a cavity segment 126 and may supply tobacco components such as nicotine or components that provide a smoking taste when heated. As illustrated, the cavity rod 120 may include a first filter segment 122, a second filter segment 124, and the cavity segment 126 that may be disposed between the first filter segment 122 and the second filter segment 124.

The first filter segment 122 may be disposed at the upstream end of the medium receiving rod 100. The first filter segment 122 may perform a function of preventing the medium pulp P from falling off and may allow the cavity segment 126 to be disposed at the appropriate position in the aerosol-generating device 200 when the medium receiving rod 100 is inserted into the aerosol-generating device 200. In addition, the first filter segment 122 may prevent liquefied aerosol from flowing into the aerosol-generating device 200 during smoking. The first filter segment 122 may include a paper filter. It is desirable that the paper material is arranged in a longitudinal direction of the medium receiving rod 100 in order to secure a smooth airflow path, but is not limited thereto.

The second filter segment 124 may be disposed downstream of the first filter segment 122 and, in particular, may be disposed at the downstream end of the cavity segment 126. The second filter segment 124 may further perform filtering and cooling functions for aerosol in addition to a function of forming a cavity with the first filter segment 122. The second filter segment 124 may include a paper filter. It is desirable that the paper material is arranged in a longitudinal direction of the medium receiving rod 100 in order to secure a smooth airflow path, but is not limited thereto.

The cavity segment 126 is a segment having a cavity and may be positioned between the first filter segment 122 and the second filter segment 124. Also, the cavity segment 126 may include a medium from which nicotine is aerosolized when heated. The medium may be in the form of pulp P, reconstituted tobacco, general cut tobacco, or the like. It is desirable that the medium is in the form of a pulp-type medium P. The medium pulp P may be tobacco pulp or nicotine pulp, but is not limited thereto. In addition, the cavity segment 126 may include a pH adjuster. The pH adjuster may desirably be an alkaline salt, and may be, for example, potassium carbonate, sodium hydrogen carbonate, calcium oxide, or the like, but is not limited thereto. In addition, the pH adjuster, which generates the least negative scent during puffing, may be selected and used. When the pH adjuster is included in the cavity segment 126, the pH of the tobacco pulp P included in the cavity segment 126 increases, and accordingly, even when the medium is heated with a relatively low temperature, nicotine in the tobacco pulp P may be sufficiently transferred. As a result, nicotine may be transferred only by heat transferred to the tobacco pulp P by hot aerosol flowing along the airflow path in the medium receiving rod 100, without a need for direct heating of the cavity segment 126. The pH adjuster may be included in the medium pulp P by being mixed together during a manufacturing process of the medium pulp P. Alternatively, the pH adjuster may be disposed at a position separate from the medium pulp P in the cavity segment 126.

The medium pulp P (e.g., tobacco pulp P) may be manufactured by a compression process. The compression granulation process corresponds to a wet process, and has a relatively higher nicotine transition rate of the generated tobacco pulp P compared to the fluidized bed granulation process. Accordingly, when the temperature at which the pulp P is heated is relatively low, it may be more advantageous for the nicotine transition to include the tobacco pulp P manufactured by the compression granulation process than the tobacco pulp P manufactured by the fluidized bed granulation process.

The filter rod 140 may be positioned downstream of the cavity rod 120 and may perform a filtering function for aerosol. For this, the filter rod 140 may include filter materials such as a paper, cellulose acetate fiber, and the like. The filter rod 140 may further include a wrapper wrapping filter materials.

The filter rod 140 may include a cooling segment 142 and a mouthpiece segment 144. The cooling segment 142 may perform a cooling function for aerosol, and the mouthpiece segment 144 may perform a filtering function for aerosol.

In addition, the filter rod 140 may be manufactured to generate flavors. For example, a flavoring liquid may be sprayed onto the filter rod 140. Alternatively, a separate fiber to which the flavoring liquid is applied may be inserted into the filter rod 140. As another example, referring to FIG. 2b, the mouthpiece segment 144 may include a flavoring agent capsule C. In some cases, the filter rod 140 may further include at least one segment that performs another function.

The medium receiving rod 100 as described above may be a disposable cigarette that is received in the aerosol-generating device 200 and discarded after being used once. When the medium receiving rod 100 is configured for one-time use, the uniformity and durability of a taste of smoking may be higher than that of a multiple use cartridge type that is puffed about 50 to 100 times. In addition, when the medium receiving rod 100 is configured for one-time use, hygiene may be improved compared to when it is configured for multiple use.

FIGS. 3a and 3b illustrate the aerosol-generating system 10 according to some example embodiments and illustrate a state in which the medium receiving rod 100 is received in the aerosol-generating device 200 as an example. FIG. 3a illustrates the aerosol-generating system 10 in which the cartridge 220 and the heater 230 are disposed in parallel, and FIG. 3b illustrates the aerosol-generating system 10 in which the cartridge 220 and the heater 230 are disposed in a line.

As illustrated in FIGS. 3a and 3b, the aerosol-generating system 10 may generate aerosol by heating the liquid composition inside the cartridge 220 by the heater 230 of the aerosol-generating device 200, and nicotine may be generated as the medium pulp particles P (e.g., tobacco pulp particles P) are indirectly heated by aerosol passing through the medium receiving rod 100. As described above, the minimum transferable temperature of nicotine (i.e., the lowest temperature at which nicotine is aerosolized) is lowered by the pH adjuster included in the cavity segment 126, and thus nicotine may be transferred (i.e., nicotine may be aerosolized from the medium pulp particles P and move in a downstream direction) at a relatively low temperature compared to the case where nicotine is transferred by burning tobacco leaves. The generated nicotine may be delivered to a user along an airflow path (see arrow directions of FIGS. 3a and 3b) with aerosol.

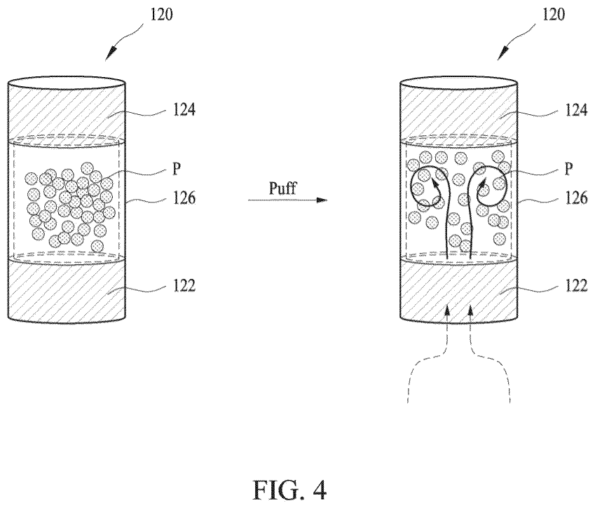

FIG. 4 is a diagram illustrating a state in which a vortex is generated in the medium receiving rod 100 according to an example embodiment. When certain conditions are satisfied, the vortex is generated in the cavity segment 126 during puffing, and due to the generated vortex, a plurality of medium pulp particles P (e.g., tobacco pulp particles P) may be mixed and uniformly heated. As the airflow introduced by the puff meets a plurality of tobacco pulp particles P moved in a downstream direction by the puff, irregular airflow may be formed, and accordingly the vortex may be generated. In addition, a plurality of tobacco pulp particles P may be well mixed and uniformly heated by the generated vortex. In this case, the burnt taste may be reduced, and the taste of smoking may be improved.

As a condition for the vortex to occur, there must be sufficient empty space aside from the pulp in the cavity segment 126. It was confirmed that, according to the experimental results, when the density of tobacco pulp P is less than or equal to about 1.2 g/cm³, the probability of occurrence of the vortex is relatively high, and when the diameter of tobacco pulp P is less than or equal to about 1.2 mm, the probability of occurrence of the vortex is relatively high. While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

1. An aerosol-generating device, comprising:
a receiver for receiving a medium receiving rod in a replaceable manner;
an atomizer that generates aerosol; and
a power supply for providing power required to heat the atomizer,
wherein a medium included in the medium receiving rod is transferred by the aerosol passing through the medium receiving rod.

2. The aerosol-generating device of claim 1, wherein the medium receiving rod comprises an alkaline pH adjuster.

3. The aerosol-generating device of claim 1, wherein the medium receiving rod comprises:
a first filter segment disposed at an upstream end of the medium receiving rod;
a second filter segment disposed downstream of the first filter segment;
a cavity segment disposed between the first filter segment and the second filter segment; and
a filter rod disposed at a downstream end of the medium receiving rod,
wherein the filter rod comprises a cooling segment and a mouthpiece segment, and the cavity segment includes the medium provided in a form of medium pulp.

4. The aerosol-generating device of claim 1, wherein the medium is provided in a form of tobacco pulp.

5. The aerosol-generating device of claim 4, wherein the tobacco pulp is manufactured by a compression process.

6. The aerosol-generating device of claim 1, wherein the medium receiving rod comprises a disposable cigarette.

7. The aerosol-generating device of claim 1, wherein the atomizer comprises:
a liquid storage tank for storing a liquid composition that generates the aerosol;
a liquid transfer means for facilitating a transfer of the liquid composition; and
a heater for heating the liquid composition.

8. The aerosol-generating device of claim 7, wherein the liquid composition of the atomizer further comprises a flavoring agent.

9. The aerosol-generating device of claim 7, wherein a heating temperature of the heater is 270° C. or less.

10. A medium receiving rod for an aerosol-generating device, comprising,
a first filter segment disposed at an upstream end of the medium receiving rod;
a second filter segment disposed downstream of the first filter segment; and
a cavity segment disposed between the first filter segment and the second filter segment,
and comprising medium pulp and a pH adjuster.

11. The medium receiving rod of claim 10, wherein the pH adjuster comprises an alkaline salt.

12. The medium receiving rod of claim 10, further comprising a filter rod disposed at a downstream end of the medium receiving rod, and comprising a cooling segment and a mouthpiece segment.

13. The medium receiving rod of claim 12, wherein the mouthpiece segment comprises a flavoring agent capsule.

14. The medium receiving rod of claim 10, wherein the first filter segment and the second filter segment comprise a paper material.
